(19) United States
(12) Patent Application Publication
(10) Pub. No.: US 2024/0347849 A1
(43) Pub. Date: Oct. 17, 2024

(54) BATTERY ARRANGEMENT HAVING A THERMAL PROTECTION DEVICE, MOTOR VEHICLE, AND METHOD FOR PRODUCING A BATTERY ARRANGEMENT

(71) Applicant: AUDI AG, Ingolstadt (DE)

(72) Inventors: Ruben HEID, BammentaI (DE); Matthias WlMMl, Gundelsheim (DE)

(73) Assignee: AUDI AG, Ingolstadt (DE)

(21) Appl. No.: 18/631,413

(22) Filed: Apr. 10, 2024

(30) Foreign Application Priority Data
Apr. 12, 2023 (DE) 102023109120.4

(51) Int. Cl. H01M 50/367; H01M 10/613; H01M 10/625; H01M 10/6556; H01M 50/209; H01M 50/249

(52) U.S. Cl. CPC H01M 50/367; H01M 10/613; H01M 10/625; H01M 10/6556; H01M 50/209; H01M 50/249; H01M 2200/10; H01M 2220/20

(57) ABSTRACT

A battery arrangement, which includes a thermal protection device, a housing component, and a battery module having multiple battery cells, each of which has a releasable cell degassing opening. The battery module has a module side which is opposite the housing component with respect to a first direction, and which has a contiguous degassing subregion in which all cell degassing openings are arranged. Between the housing component and the degassing subregion there is a gap subregion having passage areas, which are each arranged directly below a respective, assigned cell degassing opening with respect to the first direction. The thermal protection device is arranged in the gap subregion and is formed using a thermally expandable material in such a way that it expands when a predetermined limiting temperature is exceeded.

### FIELD

The invention relates to a battery arrangement for a motor vehicle, having a thermal protection device, wherein the battery arrangement comprises a housing component and a battery module having multiple battery cells, each of which has a first cell side and a releasable cell degassing opening arranged on the first cell side, wherein the battery module has a first module side which faces toward the housing component and is opposite to the housing component with respect to a first direction, wherein the first module side is at least partially formed by the respective first cell sides and has a contiguous degassing subregion in which all cell degassing openings of the battery cells are arranged. Furthermore, the battery arrangement comprises a gap between the housing component and the first module side, which has a first contiguous gap subregion which is located between the housing component and the degassing subregion and which extends along the entire degassing subregion, wherein the first gap subregion comprises a number of passage areas corresponding to the number of cell degassing openings, each of which is arranged directly below a respective, assigned cell degassing opening in relation to the first direction, so that if gas emerges from the battery cell, a gas emerging through its released cell degassing opening enters the assigned passage area. Furthermore, the invention also relates to a motor vehicle having such a battery arrangement, and a motor vehicle.

### BACKGROUND

High-voltage batteries for motor vehicles known from the prior art have multiple battery cells, which are arranged, for example, in a battery housing. The battery cells can be combined into battery modules and thus form corresponding cell stacks, for example. In addition, battery cells typically comprise a cell degassing element or a releasable cell degassing opening, such as a bursting membrane. In case of a thermal runaway of a battery cell, an excess pressure results therein, which can be dissipated by opening this bursting membrane, by which uncontrolled explosion of the cell can be prevented. These harmful gases emerging from a battery cell in case of such a thermal runaway can, for example, be introduced into a gas discharge channel and discharged from the vehicle.

DE 10 2021 103 378 B3 describes a traction battery for a motor vehicle having a plurality of battery cells and a battery housing having a plurality of housing walls, which enclose a receptacle space for receiving the battery cells and of which at least one housing wall has a degassing unit for discharging a hot gas of at least one of the battery cells from the receptacle space. In particular, the degassing unit can have a plurality of degassing elements, wherein each battery cell is assigned a degassing element. The degassing element can be designed as a bursting element. In case of a fault, when at least one of the battery cells releases hot gas, the bursting membrane ruptures and the hot gas can emerge from the receptacle space via the released opening. In addition, the traction battery has a degassing collector that receives the hot gas released from the receptacle space in order to cool it down there. The degassing space is delimited by a heat shield, which is displaceable downwards from the housing base by the pressure that the hot gas applies to the heat shield, so that the degassing space is enlarged or expanded by the hot gas. The heat shield also has an outlet having openings that allow gas to be exchanged with the surroundings. At a distance from the openings, a material that foams when exposed to heat is applied, which closes the openings and prevents the hot gas stream from emerging into the surroundings. This can prevent an introduction of heat caused by the hot gas into the surroundings of the traction battery.

If thermal runaway of a battery cell of a battery module occurs, the problem is that the associated enormous heat development often results in this thermal runaway spreading to neighboring battery cells. These are also strongly heated and then also undergo thermal runaway. This can result in thermal propagation across the entire battery module and all cells of the high-voltage battery and, in the worst case, a battery fire. It would therefore be desirable to be able to thermally decouple the neighboring cells from the cell undergoing thermal runaway as well as possible in case of a thermal runaway of a battery cell.

### SUMMARY

The object of the present invention is therefore to provide a battery arrangement, a motor vehicle, and a method which make it possible to prevent thermal spread to neighboring battery cells as efficiently as possible in case of a thermal runaway of a battery cell or at least to reduce the risk of such a thermal spread.

A battery arrangement according to the invention for a motor vehicle has a thermal protection device. In addition, the battery arrangement comprises a housing component and a battery module having multiple battery cells, each of which has a first cell side and a releasable cell degassing opening arranged on the first cell side, wherein the battery module has a first module side which faces toward the housing component and is opposite to the housing component with respect to a first direction. In addition, the first module side is at least partially formed by the respective first cell sides and has a contiguous degassing subregion in which all cell degassing openings of the battery cells are arranged. Furthermore, the battery arrangement comprises a gap between the housing component and the first module side, which in turn comprises a first contiguous gap subregion which is located between the housing component and the degassing subregion of the first module side and which extends along the entire degassing subregion. The first gap subregion comprises a number of passage areas corresponding to the number of cell degassing openings, which are each arranged directly below a respective assigned cell degassing opening in relation to the first direction, so that if gas emerges from one of the battery cells, a gas emerging through its released cell degassing opening enters the assigned passage area. The thermal protection device is arranged in the first gap subregion and is formed using a thermally expandable material in such a way that the protection device expands at least locally when a predetermined limiting temperature is exceeded and thus changes at least locally from an at least not completely sealed state to a sealed state, in which the protection device at least temporarily seals at least a first of the passage areas from at least a second of the passage areas.

The invention is based on several findings: battery cells are often arranged in a battery housing, so that the cell degassing openings face toward, for example, a wall of such a housing. Such a wall can, for example, represent the above-mentioned housing component. It is possible, for example by providing openings or predetermined breaking points in such a housing wall, to divert the gas emerging from a cell from the battery housing, for example into a gas receptacle space or a gas discharge channel for discharging the gases from the motor vehicle, or the like. Even if the battery cells are arranged having their respective cell degassing openings very close to such a passage opening in the housing wall, a certain gap or space usually still remains between this wall, namely the housing component, and the battery cells, more precisely the first cell sides having the cell degassing openings arranged thereon. This also makes it possible for the gas emerging from a battery cell to penetrate at least partially into such a gap-at least without any countermeasures-and to spread via this gap to other cells and their releasable cell degassing openings. The gas emerging from a cell has very high temperatures of several hundred degrees Celsius. If such a hot gas comes into contact with the releasable cell degassing openings of neighboring cells that are still intact and not undergoing thermal runaway, on the one hand these releasable cell degassing openings can be damaged by this extreme heat, which can trigger a thermal event, and on the other hand this results in strong heating of the cells, which also enormously promotes the thermal spread of the thermal event to neighboring cells. Due to the invention, it is now advantageously possible to prevent or at least significantly reduce the spread of such a gas in this gap by arranging the thermal protection device in this gap, more precisely in the first gap subregion defined above, which device is configured so that it seals the relevant passage area, through which, for example, the gas emerging from a cell passes through the gap, from the other passage areas or the remaining gap by thermally expanding. The thermal expansion of this protection device can advantageously be triggered by the thermal runaway of a battery cell itself. The associated heat development advantageously automatically causes the thermal expansion of the thermal protection device, at least in sections or locally at the point of heating, and thus also in a targeted manner in the area of the heat development. In addition, the invention is based on the following finding: In principle, a conventional seal, for example a sealing foam or the like, could also be used to seal these passage areas from one another. However, such a seal has the disadvantage that in order to achieve its sealing effect it would have to apply a certain restoring force to the housing component and would thus push the housing component away from the first module side. In addition, it is preferred, as explained in more detail later, that the housing component, for example, provides a cooling device for cooling the battery cells. This is to be thermally connected to the cells as well as possible. This can be achieved by a thermally conductive adhesive which is arranged between the housing component and the cells, in particular the first module side. However, the restoring force on the module component generated by a conventional foam seal poses the risk that the module component will be pushed away from the cells and the thermal connection between the cells and the cooling device will be impaired as a result. In the worst case, the thermally conductive adhesive and thus also the cooling device can partially detach from the cells, so that the cells can no longer be cooled effectively during operation. As a result, not only is the cooling effect impaired in particular, but the sealing function of the foam seal itself can no longer be reliably fulfilled. Numerous problems also arise during production: The cooling device has to be pressed against the battery module for a sufficient period of time until the thermally conductive adhesive in between is completely hardened, since if the contact force is reduced too early, there is a risk of the cooling device detaching from the battery module due to the restoring effect of the foam seal. This makes the production process more complex and longer. These problems can now be advantageously solved by the thermally expanding protection device. Since this has a significantly smaller volume in the non-triggered state, i.e., when it has not yet thermally expanded and has a temperature below the predetermined limiting temperature, this protection device also does not exert any restoring force on the housing component and/or the battery module in its non-sealing state. The thermal protection device can, in particular in its non-triggered state, i.e., in its non-sealing state, be so flat that it does not extend in the first direction over the entire height of the first gap subregion or does not even completely fill the height of the gap subregion. For example, the thermal protection device can abut the housing component and be at a distance from the battery module or can abut the battery module and be at a distance from the housing component. Theoretically, it is also conceivable that the protection device is dimensioned in terms of its height in the first direction in such a way that it affects both the battery module and the housing component, but is itself not compressed and therefore also does not exert mechanical clamping force on these two components, namely the housing component on the one hand and the battery module on the other hand. As a result, the manufacturing of such a battery module or such a battery arrangement is significantly simplified, and there is no risk, neither during manufacturing nor during operation, that the housing component will be partially detached from the battery module due to restoring forces and thus the cooling function of a cooling device, which is preferably implemented by the housing component, will be impaired and/or the sealing function for sealing the passage areas from one another in case of a thermal event will be impaired. For example, to connect the housing component to the battery module, a gap filler without adhesive properties can also be used instead of the thermally conductive adhesive mentioned above, since the strong restoring forces no longer have to be withstood. This means that there are more degrees of freedom with regard to the choice of material for such a thermal interface material when manufacturing such a battery arrangement.

The battery arrangement can be designed, for example, as a high-voltage battery. Furthermore, the battery arrangement can have not only one such battery module, but also, for example, multiple battery modules. The battery cells of such a battery module can be formed as lithium-ion cells, for example. Furthermore, the battery cell can in principle have any desired shaping and can be designed, for example, as round cells, pouch cells, or prismatic cells. The battery cells can particularly preferably be designed as prismatic cells or pouch cells and can be arranged one behind the other in a stacking direction. The stacking direction is preferably directed perpendicular to the above-defined first direction. The sum of all first cell sides, possibly with small gaps in the stacking direction, can form the first module side. The cell degassing openings can basically be arranged at any location on the first cell sides, for example also in an edge region, but are preferably arranged centrally on a respective first cell side. Furthermore, the cell degassing openings of all cells in a module are preferably on a straight line. In other words, the degassing subregion, which represents a subregion of the first module side, namely the subregion that comprises all cell degassing openings of the battery cells of the battery module, also extends in a straight line, for example parallel to the stacking direction mentioned above. The extension direction of this degassing subregion can be defined, for example, as a second direction that is perpendicular to the first direction.

The space between the housing component and the first module side borders on the one hand on the housing component and on the other hand on the first module side. This gap can in turn be subdivided into individual subregions, of which one such subregion represents the first contiguous gap subregion. This is directly adjacent to the degassing subregion of the first module side. This first gap subregion can in turn be subdivided into individual subregions, some of which represent the passage areas mentioned. Each cell degassing opening is assigned a passage area of the first gap subregion directly adjoining thereon. The gas emerging from the cell degassing opening therefore enters directly into this assigned passage area of the first gap subregion. The gas preferably passes through this and passes on the opposite side through the housing component and into a degassing channel located underneath. The passage areas can be separated from one another in the second direction, for example, by intermediate areas of the first gap subregion. This is because the cell degassing openings of two adjacent battery cells are also at a finite distance from one another in the second direction.

The thermally expanding protection device can, for example, be designed in such a way that upon expansion or in the expanded and thus sealing state it fills exactly these intermediate areas between two passage areas and in this way seals the passage areas from one another. Areas of the first gap subregion that are located next to such a passage area with respect to a third direction perpendicular to the first and second directions can also be filled by the protection device in the sealing state. The passage opening, which is assigned to a thermally continuous cell, can thus be surrounded by the protection device in the sealing state. In other words, in the sealing state, the expanded part of the protection device can enclose, for example annularly enclose, the passage opening which is assigned to a cell undergoing thermal runaway.

The thermally expandable material can also be referred to as a thermally expanding material. This means a material, preferably based on a solid, the expansion of which, i.e., increase in volume, can be triggered thermally. Thermally expanding is therefore to mean that the expansion, i.e., the volume expansion, of the material can be triggered thermally, more precisely, is triggered when the limiting temperature is reached or exceeded, in particular by an intrinsic change of a material property of the material.

The thermally expanding material is designed in such a way that this thermal expansion results in an enormous and, above all, abrupt increase in the volume of the protection device when the limiting temperature is exceeded or, more precisely, triggered by the exceeding of the limiting temperature. The normal temperature-related volume expansion of a body is thus not to be understood as a thermal expansion process like that executable by the thermally expandable material.

Thermally expanding materials are known, for example, from the fire protection coating of battery covers, for example. However, other materials of biological origin are also conceivable, for example possibly based on starch. The expanding material can be applied to a carrier medium, for example a film, and cut to the appropriate size and then fastened on the housing component, for example on a cover, preferably using an adhesive. A single-sided adhesive tape having a coating on its upper side is therefore also a solution implementable well for providing the thermal protection device. Alternatively, applying the thermal protection device, in particular the expandable material, directly to the cell or the insulating film of the cell is conceivable. In particular, the material that is thermally expandable can be applied in liquid form, i.e., to the carrier film and/or cells and/or the housing component, and then hardened.

The housing component can be part of a module housing or a battery housing. Multiple battery modules can also be accommodated at the same time in such a battery housing. However, it can also only be assigned to the battery module. The housing component preferably represents a housing base of such a battery housing or module housing, but it could also be a housing cover or a side wall of such a housing or the like.

In a further advantageous embodiment of the invention, the protection device is designed in such a way that when a first battery cell undergoes thermal runaway and gas emerges from the released cell degassing opening of the first battery cell undergoing thermal runaway and enters the first passage area, at least a first section of the protection device, which is adjoins the first passage area, thermally expands and changes into the sealing state, in particular wherein the specific limiting temperature is at least 60° C., in particular at least 70° C. or more, and in particular is at most 100° C., preferably at most 90° C.

The protection device is therefore designed in such a way that it can assume the sealing effect in a targeted manner where this is required, namely where the battery cell undergoing thermal runaway is located. If the limiting temperature of the protection device is only exceeded locally, the protection device can thus advantageously expand locally, i.e., for example, only a section of the protection device expands in the second direction, the remainder, for example, remains in the non-sealing state if the temperature of this remainder is lower than the limiting temperature or as long as the temperature of this remainder is lower than the limiting temperature. The protection device does not have to expand as a whole, but only in the areas in which its temperature exceeds the limiting temperature. This limiting temperature can in turn be selected in a simple manner by suitable material selection of the expanding material comprised by the protection device. The normal operating temperature of battery cells is in a target range which is at most 60° C. It is therefore advantageous to set the limiting temperature above this 60°° C. in order to prevent expansion from taking place during normal operation of the battery module. The limiting temperature is therefore preferably at least 70° C. or more. Furthermore, it is preferred that the limiting temperature is less than 100° C., in particular less than 90° C., for example less than 80° C. In such a temperature range, for example at 80° C., it can be assumed with near certainty that a battery cell is undergoing thermal runaway. Due to early triggering of the protection device and expanding and entering the sealing state thus caused, it is advantageously thus possible that the protection device will seal the relevant passage area particularly early. This makes the protective effect particularly effective. The protection device can, for example, enter the sealing state before gas even emerges from the battery cell undergoing thermal runaway, which causes this temperature increase. This means that the passage area is already sealed by the protection device when gas begins to emerge from the cell.

The protection device or its material can be designed in such a way that it can be easily burned through or penetrated by the emerging gas jet. In other words, the protection device can melt or be locally destroyed in the passage area through which the hot gas flows and can be broken through or penetrated by the gas jet. However, the areas directly adjacent to this passage area are at least temporarily reliably sealed by the protection device. The protection device can therefore be designed to be very temperature-stable or heat-resistant and can withstand high temperatures at least temporarily.

In a further advantageous embodiment of the invention, the housing component comprises a first housing subregion, which is arranged directly below the degassing subregion and the first gap subregion in relation to the first direction, and extends perpendicular to the first direction, in particular in the second direction defined above, along the first gap subregion, for example in the second direction defined above, wherein the first housing subregion has a number of opening areas, which are designed as predetermined breaking points and/or permanent passage openings, corresponding to the number of cell degassing openings, wherein each opening area is opposite to one of the cell degassing openings in relation to the first direction. A gas jet emerging from a relevant cell degassing opening therefore first directly enters the assigned passage area underneath and hits the assigned opening area of the housing component or passes through it. This opening area can therefore either be designed as a predetermined breaking point, for example a material weakening, in this housing component or, as is preferred, as a permanent opening or hole. In principle, it is also conceivable that the first housing subregion does not have multiple individual opening areas corresponding to the number of cell degassing openings, but rather that a continuous, slot-shaped opening area is provided in the housing subregion, to which a cell degassing opening is assigned jointly. However, for reasons of stability, individual opening areas are preferred. These can be separated from one another by thin webs.

Providing such passage openings facilitates the gas emerging from a battery housing. Especially if the opening areas are designed as holes or passage openings, there is no risk that the emergence of gas will be hindered by a predetermined breaking point that does not open properly.

In a further advantageous embodiment of the invention, the protection device is arranged on the first housing subregion and is restricted to the first housing subregion and in particular is arranged covering all of the opening regions and is arranged at a distance from the degassing subregion of the first module side with respect to the first direction. In the non-triggered state of the protection device, the protection device therefore advantageously covers all opening areas. If these are designed, for example, as passage openings or holes, they can advantageously be covered at the same time in a protective manner by the protection device. This offers additional protection against the penetration of dust or moisture, for example, and in particular also protection for the releasable sensitive cell degassing openings of the battery cells located above. The protection device is therefore preferably also designed to be elongated, for example in the form of a strip, and can extend over the entire first housing subregion, for example in the longitudinal direction, which can extend in the second direction defined above. But also perpendicular thereto, for example in a third direction, the width of the protection device can be limited to at most the width of this first housing subregion. This has the advantage that only a subregion of the gap defined above between the first module side and the housing component is provided with this protection device. Remaining areas of this gap can then advantageously be filled with a heat-conducting compound in order to promote the thermal connection between the module and the housing wall or the housing component, which is preferably designed as a cooling device. The protection device can therefore have a length in the second direction that essentially corresponds to a module length of such a battery module in the second direction. The protection device therefore preferably also extends elongated perpendicular to the first direction and extends on the one hand along the first gap subregion over all cell degassing openings and on the other hand over all assigned opening areas of the housing component. However, as already described, the protection device can be at a distance from the degassing subregion. Alternatively, the protection device can also be arranged directly on the battery module and, for example, can be at a distance from the housing component.

Therefore, it represents a further advantageous embodiment of the invention if the protection device is arranged on the first module side in the degassing subregion and restricted to the degassing subregion and in particular covering all of the cell degassing openings and is arranged at a distance from the first housing subregion with respect to the first direction. This also makes it advantageously possible for the protection device to additionally also provide protection for the releasable cell degassing openings in the non-triggered state.

In a further advantageous embodiment of the invention, the protection device comprises a carrier film on which the thermally expanding material is arranged, in particular in the form of a coating of the carrier film. The protection device can also consist of the carrier film coated using the coating, wherein the coating comprises the thermally expanding or expandable material. Such a coating can comprise, for example, the thermally expanding particles or the thermally expanded material. This coating can be applied to the carrier film, for example in liquid form. The provision of such a carrier film simplifies the manufacturing of the battery arrangement. Especially if the housing component is designed, for example, having the corresponding holes as passage areas, this film can, for example, first be arranged on these holes and covering the holes and then the liquid coating having the expanding particles can be arranged thereon and the coating can be hardened. However, the use of a film as a carrier for the material, which can be designed, for example, as a conventional metal foil and/or plastic film, also has the great advantage that the holes in the housing component that provide the opening areas can be sealed in this way. Such a film can be made leak-tight without any problems. This allows more flexibility in the material selection of the thermally expandable material. This is because it then does not have to be selected from the perspective of creating an additional sealing effect.

During production, it is also conceivable that this carrier film is first coated using the coating and then the coated carrier film is arranged on the first module side or on the housing component, depending on the design. Such a film therefore also enables more flexibility in the production process and in the sequence of the individual process steps.

The coated film is designed in such a way that the thermally expandable properties, as described for the protection device, are present in the same way for each section or subregion of the coated carrier film. The coated carrier film can thus also be designed geometrically as already described for the protection device. In particular, the coated carrier film can be designed to be correspondingly elongated and extend over the entire degassing subregion of the first module side or the entire first housing section in the second direction.

In a further advantageous embodiment of the invention, the housing component represents a cooling device which has at least one cooling channel section through which a coolant can flow. It is advantageous if such a cooling channel section is provided in an area of the housing component which is arranged next to the first housing subregion with respect to a third direction. The cooling channel sections are therefore not to be arranged in the areas of the housing component that are penetrated by the hot gas jet in the case of cell degassing. This means that the housing component can also advantageously provide a cooling effect for cooling the battery cells during normal operation of the battery arrangement. Above all, cooling can be provided on the side of the battery cell on which the cell degassing opening is also arranged. This advantageously makes it possible, for example, to provide a gas discharge channel below this housing component. The harmful gas to be discharged can thus be guided past the cooling device provided by the housing component. As a result, the harmful gas is thermally separated particularly well from the remaining battery cells located above the housing component, and the harmful gas can also be cooled down at the same time by the cooling device.

In a further advantageous embodiment of the invention, the housing component has at least a second housing subregion which is arranged next to the first housing subregion with respect to a third direction, wherein the first module side has a second module side subregion which is arranged next to the degassing subregion with respect to the third direction and is opposite to the second housing subregion with respect to the first direction, wherein between the second housing subregion and the second module side subregion a second gap subregion of the gap is arranged, which is filled using a thermal interface material. This second gap subregion of the gap can therefore directly adjoin the housing component, namely the second housing subregion, and on the other hand can directly adjoin the battery module, namely in the second module side subregion. A particularly good thermal coupling between the housing component and the battery module can be produced by the thermally conductive compound or the thermal interface material, which preferably completely fills this gap subregion. This is particularly advantageous if the housing component is designed as a cooling device at the same time.

As already described above, it is preferred that a respective cell degassing opening is located in the middle of the first cell side. Correspondingly, corresponding module side subregions can be arranged on both sides of the degassing subregion, in particular again in relation to the third direction, which can be connected to the housing component via a thermal interface material. In other words, the housing component can also have at least one third housing subregion, which is arranged next to the first housing subregion with respect to the third direction, so that the first housing subregion is arranged between the second and third housing subregions, and also the first module side can have a third module side subregion which is arranged next to the degassing subregion with respect to the third direction, so that the degassing subregion is arranged between the second and third module side subregions.

Furthermore, the gap can also have a third gap subregion, so that the first gap subregion is arranged between the second and third gap subregions with respect to the third direction, and also this third gap subregion, which is arranged with respect to the first direction between the third housing subregion and the third module side subregion, in particular again directly adjoining thereon, can be filled using a thermal interface material, preferably completely. The thermal interface material, which fills or fills up the second gap subregion and/or third gap subregion, can also be part of the battery arrangement.

Furthermore, the invention also relates to a high-voltage battery having a battery arrangement according to the invention or one of its embodiments.

Furthermore, the invention also relates to a motor vehicle having a battery arrangement according to the invention or one of its embodiments.

The motor vehicle according to the invention is preferably designed as an automobile, in particular as a passenger car or truck, or as a passenger bus or motorcycle.

Furthermore, the invention relates to a method for producing a battery arrangement for a motor vehicle, having a thermal protection device, wherein a housing component and a battery module having multiple battery cells are provided, each of which has a first cell side and a releasable cell degassing opening arranged on the first cell side, wherein the battery module has a first module side which is at least partially formed by the respective first cell sides and has a contiguous degassing subregion in which all cell degassing openings of the battery cells are arranged. The battery module is arranged here having the first module side facing toward the housing component, so that the first module side is opposite to the housing component with respect to a first direction, and so that a gap is formed between the housing component and the first module side, which comprises a first contiguous gap subregion which is located between the housing component and the degassing subregion and which extends along the entire degassing subregion, wherein the first gap subregion comprises a number of passage areas corresponding to the number of cell degassing openings, each of which is arranged directly below a respective, assigned cell degassing opening in relation to the first direction after the battery module is arranged in relation to the housing component, so that if gas emerges from the battery cell, the gas emerging through its released cell degassing opening enters the assigned passage area. The thermal protection device is arranged in such a way that it is located in the first gap subregion after being arranged. The thermal protection device is formed using a thermally expanding material in such a way that the protection device expands when a predetermined limiting temperature is exceeded and thus passes from an at least not completely sealed state to a sealed state, in which the protection device at least temporarily seals at least a first of the passage areas from at least a second of the passage areas.

The invention also includes refinements of the method according to the invention, which have features as have already been described in conjunction with the refinements of the battery arrangement according to the invention. For this reason, the corresponding refinements of the method according to the invention are not described again here.

The invention also comprises the combinations of the features of the described embodiments. The invention therefore also comprises implementations that respectively have a combination of the features of several of the described embodiments, provided that the embodiments have not been described as mutually exclusive.

### BRIEF DESCRIPTION OF THE FIGURES

Exemplary embodiments of the invention are described hereinafter. In the figures:

FIG. 1 shows a schematic cross-sectional representation of a battery arrangement according to an example not belonging to the invention;

FIG. 2 shows a schematic cross-sectional representation of a battery arrangement according to one exemplary embodiment of the invention in a non-expanded state of the protection device;

FIG. 3 shows a further cross-sectional representation in a different cross section of the battery arrangement from FIG. 2 according to an exemplary embodiment of the invention;

FIG. 4 shows a schematic cross-sectional representation of the battery arrangement from FIG. 2 in an expanded state of the production device according to an exemplary embodiment of the invention;

FIG. 5 shows a further cross-sectional representation of the battery arrangement from FIG. 4 according to an exemplary embodiment of the invention; and

FIG. 6 shows a schematic representation of a battery arrangement during a production process according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, the same reference numerals respectively designate elements that have the same function.

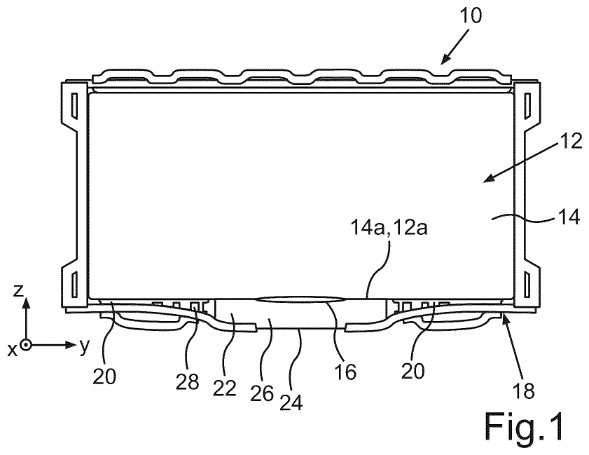

FIG. 1 shows a schematic representation of a battery arrangement 10 according to an example not belonging to the invention. The battery arrangement 10 comprises a battery module 12, which in turn can comprise multiple battery cells 14, for example. Each of battery cell 14 has a releasable cell degassing opening 16. These are provided, for example, on a lower side 14a of a respective battery cell 14, which is also at the same time part of a module lower side 12a of the battery module 12. Furthermore, the battery arrangement 10 comprises a cooling device 18. This is connected to the battery module 12 via a thermal interface material 20. A middle area 22 below the battery module 12 can be left out of the thermal interface material 20, since the gas from emerging from this battery cell 14, in particular from its cell degassing opening 16, is to be guided through this middle area 22 in case of a thermal runaway of a battery cell 14 should, in particular through the cooling device 18. For this purpose, the cooling device 18 can have a corresponding opening 24 directly below the cell degassing opening 16.

However, since multiple cells 14 can now be arranged one behind another, for example in a stacking direction, which in the present case corresponds to the x direction shown, there would fundamentally be a fluidic connection between the individual cell degassing openings 16 if this intermediate are 22 were designed as an empty space. There were therefore at least internal considerations of providing this gap 22 with a seal, for example a conventional foam seal 26. This seal 26 is then also to function at the same time as a protective shield, in case of a hot gas stream emerging from a cell 14, for the remaining cells 14 and their cell degassing openings 16. Such a foam shield, i.e., a foam protective shield, is compacted during the module production. This results in restoring forces that push the cooling device 18 away from the module 12 in the area of this seal 26. These restoring forces can result in detachment of the cooling connection via the thermal conduction compound 20. The detachment is designated by 28 here. Such a detachment can take place, for example, during production, for example when the heat-conducting material 20 has not yet completely hardened, but a pressing device for pressing the cooling device 18 against the module 12 has already been removed, or also during operation, for example in a motor vehicle. Such detachment 28 results in a reduction in the cooling efficiency as well as a reduction in the function of the seal 26. These problems can now be advantageously solved as described below.

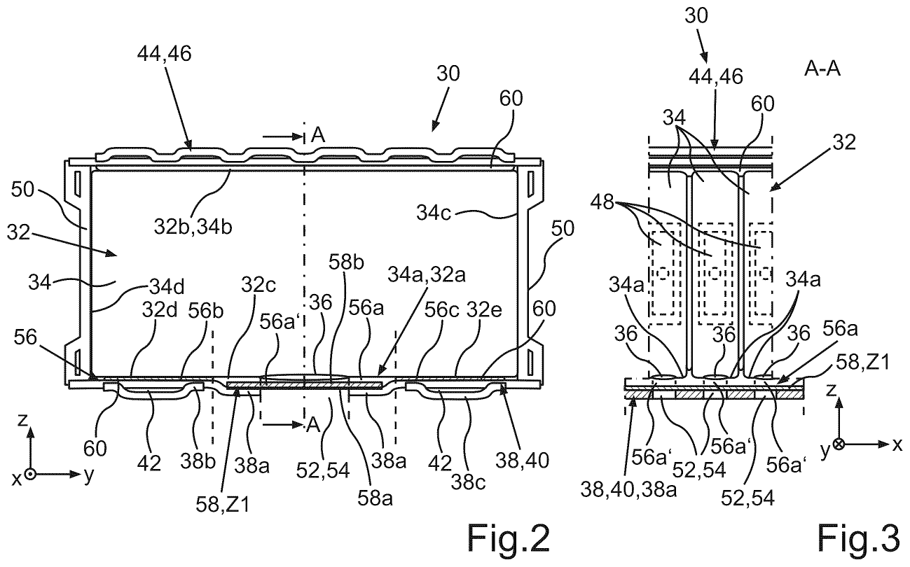

FIG. 2 shows a schematic representation of a battery arrangement 30 according to one exemplary embodiment of the invention in this regard. This battery arrangement 30 can also comprise a battery module 32 having multiple battery cells 34. The battery cells 34 can be formed as lithium-ion cells, for example. In this example, the battery cells 34 are also designed as prismatic battery cells and are arranged next to one another in a stacking direction, which in the present case corresponds to the x direction. A respective battery cell 34 has a first cell side 34a, which at the same time also provides a first module side 32a of the battery module 32. In the present case, a releasable cell degassing opening 36 is arranged in the middle on the first cell side 34a as an example. The cell degassing opening 36 can be embodied, for example, as a bursting membrane. Furthermore, the battery arrangement 30 comprises a housing component 38, which in the present case is designed as a cooling device 40 having cooling channel sections 42 through which a coolant can flow. In addition, the battery module 32 has an upper side 32b opposite to the first side 32a, which in turn can be formed by the respective upper sides 34b of the respective battery cells 34, which are comprised by the battery module 32. In this example, a housing cover 44 in the form of a cooling device 46 is also formed on this upper side 32b. This advantageously enables such a battery module 32 to be cooled on both sides. A respective cell 34 also has a third side 34c and a fourth side 34d. The poles of a respective cell 34 can, for example, be arranged on this third side 34c and/or fourth side 34d. For example, a first pole 48 can be arranged on the fourth side 34d (see FIG. 3) and a further pole, which is not shown here, however, on the opposite third side 34c. In addition, the battery arrangement 30 can also comprise two side plates 50 which connect the two housing components 44, 38 to one another. A module housing, for example, can be provided by the side plates 50 and the two housing components 44, 38. The housing base 38 can also function as the overall battery housing base at the same time. Multiple such battery arrangements 30 can be arranged next to each other in the y direction to form a high-voltage battery.

The module side 32a can now be divided into multiple subregions in the y direction for easier description. One of these subregions represents a degassing subregion 32c. In addition, the module side 32a can also have a second module side subregion 32d and a third module side subregion 32e, wherein the degassing subregion 32c is arranged between the second and third module side subregions 32d and 32e with respect to the y direction. These respective subregions 32c, 32d, 32e of the first module side 32a can extend in the x direction over the entire length of the battery module 32 and thus over all cells 34. All releasable cell degassing openings 36 of the cells 34 comprised by the module 32 are thus arranged in the degassing subregion 32c of the first module side 32a. In an analogous manner, the housing component 38 can also be divided into three subregions. One of these represents a first housing subregion 38a, which is opposite to the degassing subregion 32a with respect to the z direction. In and against the y direction shown, a second housing subregion 38b and a third housing subregion 38c can each adjoin this first housing subregion 38a. The above-mentioned cooling channel sections 42 are preferably arranged in the second and third housing subregions 38b, 38c and not in the first housing subregion 38a. In order to enable gas to emerge easily from a battery cell 34 in case of a thermal runaway thereof, the housing component 38, in particular in the first housing subregion 38a and the cell degassing opening 36, has an opening area 52 directly opposite with respect to the z direction, which in the present example is designed as a hole 54.

There is also a gap 56 between the battery module 32 or the respective cells 34 and the housing component 38. This can also be divided into individual subregions. The gap 56 comprises a first gap subregion 56a, a second gap subregion 56b, and a third gap subregion 56c. The first gap subregion 56a is arranged between the second and third gap subregions 56b, 56c. In addition, the first gap subregion 56a is located directly below the degassing subregion 32c of the module 32 and directly above the first housing subregion 38a with respect to the z direction. The second gap subregion 56b is located between the second module side subregion 32d and the second housing subregion 38b, and the third gap subregion 56c is located between the third module side subregion 32e and the third housing subregion 38c.

In addition, the first gap subregion 56a can now be subdivided again. In particular, subregion 56a′ is designated as the passage area 56a′, which is located directly between the releasable cell degassing hole 36 in the opening area 52 in the housing component 38. Thus, the gas flow coming out of a cell 34 undergoing thermal runaway passes through this passage area 56a′.

A thermal protection device 58 is now advantageously arranged in this first gap subregion 56a. This can also be referred to as a thermally expanding or expandable foam shield, i.e., as a thermally expanding or expandable foam protective shield. For example, this protection device 58 can comprise a carrier film 58a and a thermally expanding fire protection material 58b arranged on this carrier film 58a. This expanding fire protection material 58b can be applied to this film 58a, for example in the form of a coating.

FIG. 2 shows the protection device 58 in an unexpanded state Z1. The protection device 58 has this first state Z1 as long as a certain limiting temperature is not exceeded.

FIG. 3 shows a schematic representation of the battery arrangement 30 in a cross section along cross-sectional area A-A, as illustrated in FIG. 2. In this example, the protection device 58 is arranged on the cooling device 40 in the first housing section 38a, so that the respective holes 54 corresponding to the cell degassing openings 36 are covered by the protection device 58. The protection device 58 can, for example, be formed as a band or strip and in particular can extend over the entire length of the battery module 32 in the x direction. In the y direction, however, the protection device 58 is limited to the first housing subregion 38a. This has the advantage that the two second and third gap subregions 56b, 56c adjoining the first gap subregion 56a can each be filled with a thermal interface material 60° C. This can be designed as a thermally conductive adhesive or in this case also as a gap filler, i.e., as a thermally conductive compound that does not necessarily have to have adhesive properties. This is because no restoring forces are exerted on the cooling device 40 by this thermally expanding foam shield 58 in the first state Z1. In other words, in the normal state, i.e., when there is no thermal event and the protection device 58 is thus in the unexpanded state Z1, the cooling device 40 is not pushed away from the module 32 by the protection device 58. This simplifies production and also reduces the risk of the cooling device 40 becoming detached from the module 32 during operation.

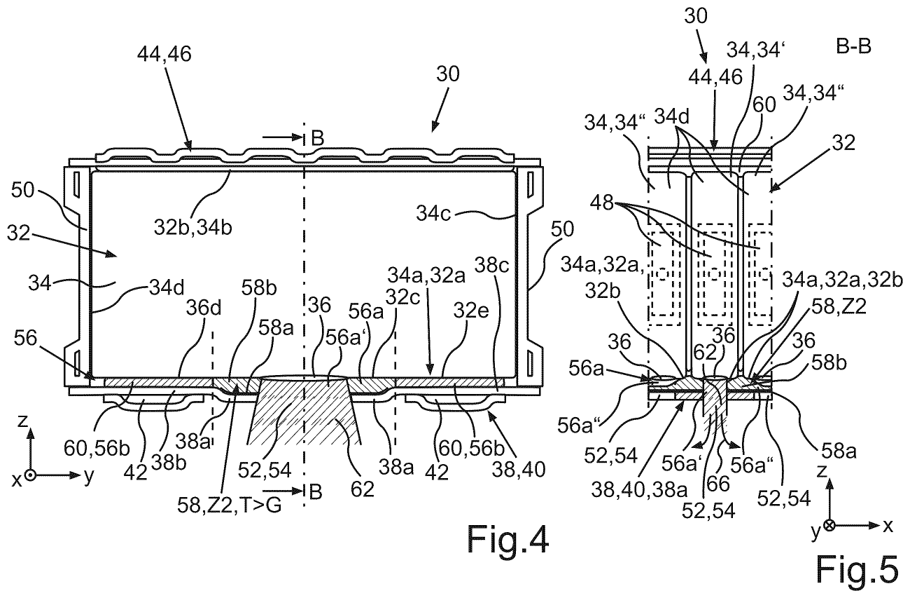

If a thermal event or a thermal runaway of a cell 34 occurs, this protection device 58 expands at least locally, as is illustrated in FIG. 4 and FIG. 5.

FIG. 4 and FIG. 5 each show a schematic representation of the battery arrangement 30 from FIG. 2, namely in a state in which a cell 34 thermally runs away. In this case, the protection device 58 is now also in an expanded state Z2. A temperature T of the protection device 58 now exceeds a limiting temperature G assigned to the material 58b, so that the material or the protection device 58 expands and thus assumes a sealing function. FIG. 5 shows the battery arrangement 30 along section line B-B, as shown in FIG. 4.

The protection device 58 or the thermally expanding material 58b is designed in such a way that this thermal expansion results in an enormous and, above all, abrupt volume increase of the protection device 58. The normal temperature-related volume expansion of a body is thus not to be understood as such a thermal expansion process. For example, due to such a thermally triggered expansion, the protection device 58 can at least double or triple or even quadruple its volume and so on. In addition, this expansion begins abruptly as soon as the limiting temperature G is exceeded. This is preferably above 60°° C., for example 70° C. or 80° C. This means that this expansion process can be triggered very early.

The protection device 58 is therefore expanded in its sealing state Z2, at least locally, so that it locally fills the first gap subregion over its entire height in the z direction.

This can be seen particularly well in FIG. 5. The subregion of the first gap region 56a, through which the gas jet 62 of the cell 34′ undergoing thermal runaway passes, is again designated by 56a′ and can, for example, represent a first passage area 56a′. The passage areas of the adjacent cells 34″ are designated by 56a″. As can be seen, the protection device 58 in the expanded state Z2 can make it possible to seal the first passage area 56a′, through which the gas jet 62 passes, from the adjacent passage areas 56a″. As a result, no gas 62 can reach the adjacent cells 34″ via the first gap subdivision 56a, in particular their releasable cell degassing openings 36. This can significantly reduce the risk of thermal spread to adjacent cells. The thermal protection device 58 provides a protective barrier for adjacent cells 34″ by way of the expanding material 58b.

The cell gases emerging through the opening area 52 can be discharged to the side, for example in or against the x direction. This is illustrated by the arrows 66.

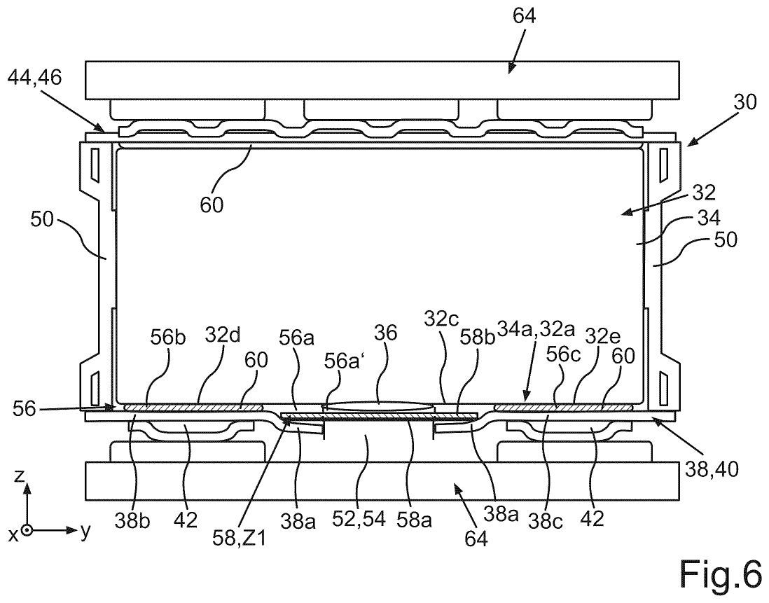

FIG. 6 shows a schematic representation of the battery arrangement 30, as described for FIG. 2 to FIG. 5, during a production process. In the course of such a production process, a mounting device 64 can be used, by means of which a contact pressure can be exerted on the battery arrangement 10. This allows, for example, the cooling plates to be pressed against the module 32 during at least part of the curing process of the heat conduction compound 60. The cooling plates are again designated by 38, 44, or 40 and 46. As can be seen, the protection device 58 is in the unexpanded state Z1 during this. The protection device 58 is arranged on the lower cooling plate 40 and does not contact the battery module 32 in this state. Accordingly, no restoring force can be exerted on the battery module 32. This makes it possible, for example, to use a gap filler instead of a thermally conductive adhesive as the thermal interface material 60. In addition, it is not necessary to wait until the next assembly or method step until the heat-conducting compound 60 has completely hardened, but rather, for example, only until the cooling plate 40 sufficiently adheres to the module 32. This reduces the risk of the cooling plate 40 becoming detached from the module 32 both during production and during operation.

Overall, the examples show how the invention can provide a thermally expandable cell shield. This is provided in the form of the thermal protection device described. This can now combine multiple functions. On the one hand, it can be made of a heat-resistant material. It enables the cell vent, i.e., the releasable cell degassing opening, to be sealed in the surrounding area, at least in a situation when harmful gases emerge from the relevant cell, so that they cannot come into contact with the adjacent cells and can flow out downwards. The protection device 58, namely the thermally expanding foam shield, is in the area of the opening cell event and at the same time seals peripherally due to the thermal expansion. This means that unaffected cells can be protected from hot harmful gas. Cells that are not affected by thermal runaway can be protected as well as possible from the harmful gas and its heat. The foam shield, which is undamaged in this area, serves as a barrier. A solid-based material can be used as the thermally expanding material, which expands when heat occurs, for example at a certain limiting temperature, and thereby fulfills the functions described above. By using an expanding material, no restoring forces arise during the manufacturing process that would bring about the negative effects described above. Such a material would not put any stress on the layer of the thermally conductive adhesive or thermal interface material and would only develop its function as soon as it is required in the vehicle. This allows expenditures in production to be greatly reduced and vehicle functions to be carried out better.

1. A battery arrangement for a motor vehicle, having a thermal protection device, comprising:
a housing component and
a battery module having multiple battery cells, each of which has a first cell side and a releasable cell degassing opening arranged on the first cell side,
wherein the battery module has a first module side which faces toward the housing component and is opposite to the housing component with respect to a first direction, which is at least partially formed by the respective first cell sides, and which has a contiguous degassing subregion in which all of the cell degassing openings of the battery cells are arranged,
wherein the battery arrangement has a gap between the housing component and the first module side, which comprises a first contiguous gap subregion which is between the housing component and the degassing subregion and which extends along the entire degassing subregion,
wherein the first gap subregion comprises a number of passage areas corresponding to the number of cell degassing openings, which passage areas are each arranged directly below a respective assigned cell degassing opening in relation to the first direction, so that if gas emerges from one of the battery cells, a gas emerging through its released cell degassing opening enters the assigned passage area,
wherein the thermal protection device is arranged in the first gap subregion and is formed using a thermally expandable material in such a way that the protection device expands when a predetermined limiting temperature is exceeded and thus passes from an at least not completely sealed state to a sealed state, in which the protection device at least temporarily seals at least a first of the passage areas from at least a second of the passage areas.

2. The battery arrangement according to claim 1, wherein the protection device is designed in such a way that when a first battery cell undergoes thermal runaway and gas emerges from the released cell degassing opening of the first battery cell undergoing thermal runaway and enters the first passage area, at least a first section of the protection device, which is adjoins the first passage area, thermally expands and passes into the sealing state, in particular wherein the specific limiting temperature is at least 60° C., in particular at least 70° C. or more, and in particular is at most 100° C., preferably is at most 90° C.

3. The battery arrangement according to claim 1, wherein the housing component comprises a first housing subregion, which is arranged directly below the degassing subregion and the first gap subregion with respect to the first direction, and extends along the first gap subregion perpendicularly to the first direction, in particular in a second direction,
wherein the first housing subregion has a number of opening areas corresponding to the number of cell degassing openings, which are designed as predetermined breaking points and/or permanent passage openings,
wherein each opening region is opposite to one of the cell degassing openings with respect to the first direction.

4. The battery arrangement according to claim 1, wherein the protection device is arranged on the first housing subregion and limited to the first housing subregion and in particular is arranged to cover all of the opening areas and is arranged at a distance from the degassing subregion with respect to the first direction.

5. The battery arrangement according to claim 1, wherein the protection device is arranged on the first module side in the degassing subregion and limited to the degassing subregion and in particular covering all of the cell degassing openings and is arranged at a distance from the first housing subregion with respect to the first direction.

6. The battery arrangement according to claim 1, wherein the protection device comprises a carrier film on which the thermally expanding material is arranged, in particular in the form of a coating on the carrier film.

7. The battery arrangement according to claim 1, wherein the housing component represents a cooling device which has at least one cooling channel section through which a coolant can flow.

8. The battery arrangement according to claim 1, wherein the housing component has at least a second housing subregion which is arranged next to the first housing subregion with respect to a third direction, wherein the first module side has a second module side subregion which is arranged next to the degassing subregion with respect to the third direction and is opposite to the second housing subregion with respect to the first direction, wherein, between the second housing subregion and the second module side subregion, a second gap subregion of the gap is arranged, which is filled using a thermal interface material.

9. A motor vehicle having a battery arrangement according to claim 1.

10. A method for producing a battery arrangement for a motor vehicle, having a thermal protection device,
wherein a housing component and
a battery module having multiple battery cells are provided, each of which has a first cell side and a releasable cell degassing opening arranged on the first cell side,
wherein the battery module has a first module side, which is at least partially formed by the respective first cell sides and which has a contiguous degassing subregion in which all cell degassing openings of the battery cells are arranged,
wherein the battery module is arranged having the first module side facing toward the housing component, so that the first module side is opposite to the housing component with respect to a first direction, and so that a gap is formed between the housing component and the first module side, which gap comprises a first contiguous gap subregion, which is located between the housing component and the degassing subregion and which extends along the entire degassing subregion,
wherein the first gap subregion comprises a number of passage areas corresponding to the number of cell degassing openings, which, after the battery module is arranged with respect to the housing component, are each arranged directly below a respective assigned cell degassing opening in relation to the first direction, so that if gas emerges from one of the battery cells, a gas emerging through its released cell degassing opening enters the assigned passage area,
wherein the thermal protection device is arranged so that, after the arrangement, it is in the first gap subregion and is formed using a thermally expanding material in such a way that the protection device expands when a predetermined limiting temperature is exceeded and thus passes from an at least not completely sealed state to a sealed state, in which the protection device at least temporarily seals at least a first of the passage areas from at least a second of the passage areas.

11. The battery arrangement according to claim 2, wherein the housing component comprises a first housing subregion, which is arranged directly below the degassing subregion and the first gap subregion with respect to the first direction, and extends along the first gap subregion perpendicularly to the first direction, in particular in a second direction,
wherein the first housing subregion has a number of opening areas corresponding to the number of cell degassing openings, which are designed as predetermined breaking points and/or permanent passage openings,
wherein each opening region is opposite to one of the cell degassing openings with respect to the first direction.

12. The battery arrangement according to claim 2, wherein the protection device is arranged on the first housing subregion and limited to the first housing subregion and in particular is arranged to cover all of the opening areas and is arranged at a distance from the degassing subregion with respect to the first direction.

13. The battery arrangement according to claim 3, wherein the protection device is arranged on the first housing subregion and limited to the first housing subregion and in particular is arranged to cover all of the opening areas and is arranged at a distance from the degassing subregion with respect to the first direction.

14. The battery arrangement according to claim 2, wherein the protection device is arranged on the first module side in the degassing subregion and limited to the degassing subregion and in particular covering all of the cell degassing openings and is arranged at a distance from the first housing subregion with respect to the first direction.

15. The battery arrangement according to claim 3, wherein the protection device is arranged on the first module side in the degassing subregion and limited to the degassing subregion and in particular covering all of the cell degassing openings and is arranged at a distance from the first housing subregion with respect to the first direction.

16. The battery arrangement according to claim 4, wherein the protection device is arranged on the first module side in the degassing subregion and limited to the degassing subregion and in particular covering all of the cell degassing openings and is arranged at a distance from the first housing subregion with respect to the first direction.

17. The battery arrangement according to claim 2, wherein the protection device comprises a carrier film on which the thermally expanding material is arranged, in particular in the form of a coating on the carrier film.

18. The battery arrangement according to claim 3, wherein the protection device comprises a carrier film on which the thermally expanding material is arranged, in particular in the form of a coating on the carrier film.

19. The battery arrangement according to claim 4, wherein the protection device comprises a carrier film on which the thermally expanding material is arranged, in particular in the form of a coating on the carrier film.

20. The battery arrangement according to claim 5, wherein the protection device comprises a carrier film on which the thermally expanding material is arranged, in particular in the form of a coating on the carrier film.
